(19) United States
(12) Patent Application Publication
(10) Pub. No.: US 2013/0309154 A1
(43) Pub. Date: Nov. 21, 2013

(54) FACILITY PROTECTION SYSTEM INCLUDING MITIGATION ELEMENTS

(71) Applicants: Charles Call, Albuquerque, NM (US); Ezra Merrill, Lake Oswego, OR (US); Wayne Briden, Elliott City, MD (US)

(72) Inventors: Charles Call, Albuquerque, NM (US); Ezra Merrill, Lake Oswego, OR (US); Wayne Briden, Elliott City, MD (US)

(21) Appl. No.: 13/983,758

(22) PCT Filed: Feb. 9, 2012
(86) PCT No.: PCT/US12/24441

§ 371 Date: Aug. 5, 2013

Related U.S. Application Data
(60) Provisional application No. 61/441,230, filed on Feb. 9, 2011.

(51) Int. Cl. A62B 15/00

(52) U.S. Cl. CPC A62B 15/00
USPC 423/210; 422/105

(57) ABSTRACT

A building protection system includes a plurality of sensors and a plurality of thermal deactivation units (burn boxes) deployed at key locations in the facility. When such a sensor detects a potential threat, a corresponding burn box is activated to mitigate the threat. The burn box can be disposed inside an HVAC system, or inside a room or area in which the sensor is deployed. When the burn box is deployed in an HVAC duct, the HVAC system is manipulated to direct air from the area in which the sensor detects the threat into the burn box. When the burn box is deployed in a room, the HVAC system is manipulated to prevent air from that room from spreading through the facility, while the burn box mitigates the threat.

### BACKGROUND

The problems associated with potential chemical, biological, and radiological (CBR) threats against fixed facilities such as buildings and transit facilities (airports, subways, and trains) are well documented. The ease of creating, concealing, and disseminating weapons of mass destruction (WMD) has led to threats of devastating consequences. A WMD event at a high-profile building could have a large human, political, and economic impact. The need for fast, effective, and affordable tools to quickly detect and assess potential threats is imperative. Security, law enforcement, and public health professionals need to know when a CBR attack has occurred, and quickly and efficiently take steps to mitigate the agent released into the facility.

Current approaches for protecting fixed facilities (such as buildings) against CBR threats are costly, complex, and customized approaches that lack the flexibility to tailor the level of protection for the facility owners. Furthermore, existing systems focus predominately on detection of hazardous threats only, neglecting cost effective and efficient mitigation elements. It would be desirable to provide additional technology to address the threats that CBR attacks pose on fixed facilities.

### SUMMARY

A first aspect of the concepts disclosed herein is the use of a modified matrix-assisted laser desorption/ionization time-of-flight mass spectrometer (referred to herein as a Single Particle MALDI-TOF MS) as a sensor for analyzing potential threat agents. For each facility to be protected, at least one Single Particle MALDI-TOF MS will be deployed to analyze potential threat agents. Significantly, this technology is able to identify biological species in real time, without the use of bio-molecular reagents. In the context of the terms discussed herein, this technology does not require the use of distinct tiers of instrumentation to first detect the presence of a possible threat, followed by a second instrument to identify a specific threat, thereby confirming (or not) the presence of a real bio-threat in the facility. Such an instrument that is capable of detection and identification in real-time using one instrument (i.e., the Single Particle MALDI-TOF MS) is available through TNO (The Hague, Netherlands). Single Particle MALDI-TOF MS requires one low-cost reagent, referred to as a “matrix,” to coat the biological particles in the sample. The matrix somewhat protects biological particles from laser energy that is used to partially fragment the particles. Too much fragmentation of the particle complicates analysis; what one desires is sufficient fragmentation of an intact biological particle into intact protein-sized molecules (e.g., greater than 1000 Da). The mass spectrum of these large intact molecules can be used to facilitate highly-specific identification of the original particle, as opposed to more complete destruction of the original biological particles into even more basic molecules or elemental ions. Other types of instruments capable of bio-threat identification require bio-molecular reagents, such as antibodies or nucleic acid probes and primers. This requirement for bio-molecular reagents represents undesired complexity in a field deployed instrument; as such bio-molecular reagents have a much higher cost and a relatively limited shelf life as compared to MALDI matrix chemicals. Further, where bio-molecular reagents are required, automated sample prep is often necessary but challenging, and complicates the instrument design. The technology developed by TNO enables the coating of biological particles with the matrix to be automated, enabling the instrument to be deployed in the field without requiring a technician to prepare the samples, as often is the case with conventional MALDI-TOS MS instruments. To date, Single Particle MALDI-TOF MS has not been used in a building protection system.

A second aspect of the concepts disclosed herein is the incorporation of low regret mitigation components into facilities to be protected. In an exemplary embodiment, one or more thermal deactivation units, or “burn boxes,” are coupled in fluid communication with the facility's heating, ventilation and air conditioning (HVAC) system. Burn boxes are employed in manufacturing environments, such as semiconductor manufacturing, to remove hazardous components from facility air introduced in the manufacturing process. A burn box in its basic form includes a combustion chamber and a fuel source, and gases to be treated are introduced into a high temperature environment established in the burn box to destroy chemical contaminants introduced into the facility air by the manufacturing process. Some burn boxes are coupled with scrubbers, such that the burn box performs two operations; the oxidization and thermal decomposition of contaminants with high temperature and the removal of residual contaminants and residues via a dry filter or wet scrubber. Airborne contaminants are materials that are toxic or hazardous for humans either by inhalation or by coming into contact with skin. The term contaminant or airborne contaminant is used interchangeably with the term chemical threat agent or biological threat agent. It should be understood that as used herein, and in the claims that follow, the term airborne threat agent encompasses toxins, harmful biological agents, chemical agents, and combinations thereof.

The use of a burn box is referred to as a low regret mitigation strategy, because its activation does not adversely affect the normal operations of the facility, in the event of a false alarm. Activating the burn box (or a plurality of burn boxes distributed throughout a facility) will consume energy resources, and thus incur some cost, but will not result in a major disruption of the facility. In contrast, if a facility is evacuated because a false positive, the evacuation will be very disruptive (hence, evacuations can be considered to be a high regret mitigation strategy).

In an exemplary building protection paradigm incorporating the use of burn boxes, one or more first tier sensors are deployed throughout the facility. When such a sensor detects a potential threat, a corresponding burn box is activated to mitigate the threat, destroying chemical and/or biological threat agents introduced into the ambient air. In at least one embodiment, air moving equipment (such as the building's HVAC system) is used to move air from the area in which the potential threat was detected to a burn box for treatment.

A first tier sensor can rapidly detect the presence of a potential threat, but generally cannot precisely identify the threat. First tier sensors are generally relatively low cost (the less expensive the better, because lower cost sensors can be more widely deployed, providing sensor coverage over a larger area, which can be very important in large facilities such as airports), and because they do not precisely identify specific threat agents, they can result in false positives. An exemplary first tier sensor is a continuously operated air sampler based on a particle counter that can detect an increase in a number particles present in the ambient air. Such a spike in particulate concentration can simply be the result of environmental factors (i.e., wind blowing pollen laden air into the facility) or an accidental release of a non hazardous material (such as someone spilling a container of flour, or some other innocuous powder). Such a spike could also be the result of a terrorist releasing a dangerous material (such as Bacillus anthracis, which causes anthrax) into the facility's ambient air in an intentional attack. Another exemplary first tier sensor is a continuously operated air sampler based on a stimulated biofluorescence that can detect the presence of biological particles in the ambient air, without specifically identifying those biological particles.

Once such a first tier sensor detects a potentially hazardous condition, a much more sophisticated second tier sensor is employed to determine if the potentially hazardous condition represents an actual danger. Second tier sensors are relatively more expensive, and fewer second tier sensors are likely to be deployed in the protected facility. Further, such second tier sensors may require more cumbersome sample acquisition than first tier sensors, and may require more time for analysis of the sample. Thus, there may be a considerable period of time between the triggering of a first tier sensor and the determination as to whether the threat is real or not. In an exemplary embodiment, the facility's HVAC system is manipulated to remove air proximate the location of the first tier sensor that detects the potential threat, and to direct that air into the burn box, preventing such air from coming in contact with additional people and/or parts of the facility. If the threat is confirmed to be real, then additional mitigation such as evacuation can be implemented. If the threat is not real, then the burn box activation will not disrupt normal operation of the facility. However, if the threat is real, the burn box activation (or more generally, high temperature thermal deactivation), will actively protect the facility by destroying the detected threat agent.

In another embodiment, the Single Particle MALDI-TOF MS discussed above is used to control burn box activation, as opposed to (or in addition to) a first tier sensor incapable of specifically identifying a potential threat agents. Because of the higher level of specificity of the Single Particle MALDI-TOF MS technology, this embodiment has a lower likelihood of activating the burn boxes unnecessarily due to a false alert.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a block diagram of an exemplary building protection system including at least one Single Particle MALDI-TOF MS employed to detect and specifically identify biological threats;

FIG. 2 is a block diagram of an exemplary building protection system including at least one thermal deactivation unit employed as a low regret mitigation element to destroy potential biological or chemical threat agents from air inside the facility;

FIG. 3 is a block diagram of an exemplary building protection system including a plurality of sensors and thermal deactivation units distributed throughout the facility to detect and destroy potential biological or chemical threat agents from air inside the facility;

FIG. 4 is a block diagram of an exemplary building protection system including a plurality of sensors and thermal deactivation units distributed throughout the facility to detect and destroy potential biological or chemical threat agents from air inside specific rooms in the facility;

FIG. 5 is a flow chart of an exemplary method to modify an existing facility including an HVAC system to include a building protection system including a plurality of sensors and thermal deactivation units distributed throughout the facility to detect and destroy potential biological or chemical threat agents from air inside the facility;

FIG. 6 schematically illustrates a test showing how an aerosol released in one portion of an airport disperses throughout the airport in the absence of a building protection system;

FIG. 7 schematically illustrates how the building protection systems disclosed herein can reduce such dispersion to only a small portion of the airport; and

FIG. 8 schematically illustrates an exemplary computing system suitable for use in implementing the control element of FIGS. 1 and 2 (i.e., for receiving sensor data from chemical, biological and/or radiological sensors, and activating mitigation elements such as air handling components and/or burn boxes).

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

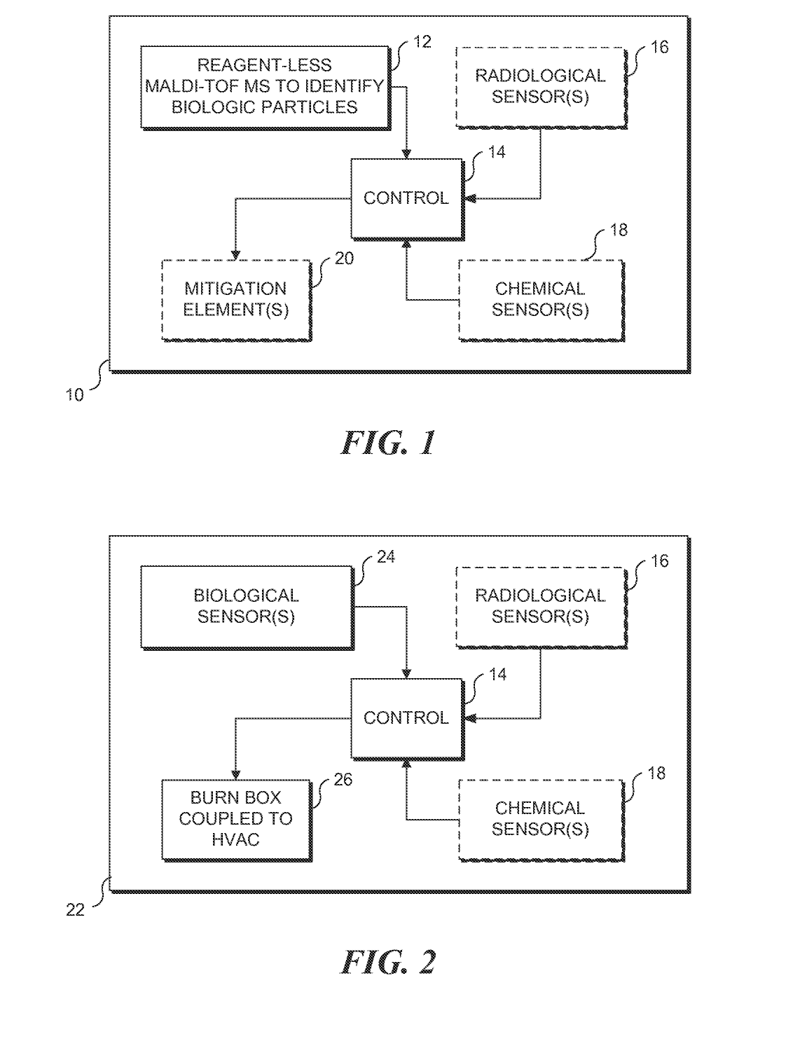

FIG. 1 is a block diagram of a facility 10 (i.e., a building or a plurality of individual buildings combined into a single facility, such as an airport, mall, or museum, such facilities being exemplary and not limiting). Facility 10 is protected from a biological attack by Single Particle MALDI-TOF MS 12, which analyzes ambient air in facility 10 in real-time to identify biological compounds present in the air. It should be recognized that depending on the size of facility 10, more than one Single Particle MALDI-TOF MS 12 may be employed.

Single Particle MALDI-TOF MS 12 is logically coupled to a control 14. If desired, facility 10 can also be protected by one or more radiological sensors 16 and one or more chemical sensors 18, each of which is similarly logically coupled to control 14. It should be understood that the data link logically coupling each sensor (chemical, biological, or radiological) to the control can be physical (i.e., hardwired), wireless, or a combination. Further, some sensors can be logically coupled to the control via a wired connection, while other sensors can use a wireless data link. Facility 10 can also be equipped with one or more mitigation elements 20, also logically coupled to control 14.

Control 14 will generally be a computing device, configured to implement specific steps upon receipt of data from one or more of the linked sensors. For example, upon receiving data from a sensor indicating a potential attack, control 14 can implement one or more of the following functions: causing an audible alarm to be activated, causing a silent alarm to be activated, causing a manipulation of the facility's HVAC system, the manipulation having been configured to limit a spread of an airborne contaminant throughout the facility, and activating one or more mitigation elements (such mitigation elements including, but not limited to, thermal deactivation units (i.e., burn boxes) coupled in fluid communication with the facility's HVAC system, chemical deactivation units coupled in fluid communication with the facility's HVAC system, and ultraviolet (UV) deactivation units coupled in fluid communication with the facility's HVAC system). Where multiple sensors and multiple mitigation elements are present, control 14 is generally configured to activate the mitigation elements best positioned to mitigate the detected threat.

In certain embodiments, the control element can be eliminated or greatly simplified. In such an embodiment, Single Particle MALDI-TOF MS 12 itself may be logically coupled to an alarm or mitigation element, such that the alarm or mitigation element is activated when Single Particle MALDI-TOF MS 12 detects one or more biological agents previously defined as necessitating activation of an alarm and/or mitigation element.

Where different types of sensors are employed in addition to Single Particle MALDI-TOF MS 12 (which is configured to identify biological agents), those additional sensors (generally chemical sensors and radiological sensors) can be positioned proximate Single Particle MALDI-TOF MS 12, or in different locations. In at least one exemplary embodiment, radiological sensors are positioned at choke points in the facility, such choke points being used to control pedestrian traffic in the facility (security checkpoints in airports are exemplary choke points, as are airline ticket counters). In at least one exemplary embodiment, chemical sensors are positioned throughout the facility at locations where people congregate, such as waiting lounges, food courts, corridors, baggage areas, and other areas. In at least one exemplary embodiment, chemical sensors are positioned next to air inlets for the facility's HVAC system, to enable chemical threat agents to be detected before such chemical threat agents are dispersed throughout the facility by the HVAC system.

In at least one exemplary embodiment, the chemical sensors and radiological sensors are first tier detectors, meaning that such sensors are relatively inexpensive (such that they can be widely deployed), and are capable of detecting potential threat agents, but are incapable of specifically identifying the threat agent. Each Single Particle MALDI-TOF MS 12 is a relatively expensive unit (approximately ten times the cost of a first tier biological sensor). In at least one exemplary embodiment, the Single Particle MALDI-TOF MS 12 is positioned in an area of the facility where the greatest number of people are at risk in an attack, and first tier biological sensors are distributed in other areas of the facility, to provide some protection at a relatively lower cost.

Referring now to a second aspect of the concepts disclosed herein (i.e., the incorporation of thermal deactivation based low regret mitigation components into a protected facility), FIG. 2 is a block diagram of a facility 22 (i.e., a building, or a plurality of individual buildings combined into a single facility, such as an airport, mall, or museum, such facilities being exemplary and not limiting). Facility 22 is protected from a biological attack by one or more biological sensors 24 (which can be relatively less expensive first tier sensors, or the Single Particle MALDI-TOF MS discussed above, or a combination of both). Each such biological sensor 24 is logically coupled to control 14. If desired, facility 22 can also be protected by one or more radiological sensors 16 and chemical sensors 18, each of which is similarly logically coupled to control 14. Again, it should be understood that the data link logically coupling each sensor (chemical, biological, or radiological) to the control can be physical (i.e., hardwired), wireless, or some combination thereof. Facility 22 is also equipped with a burn box 26 (i.e., a thermal deactivation unit), also logically coupled to control 14. In at least one exemplary embodiment, the burn box is coupled in fluid communication to the facility's HVAC system.

As noted above, control 14 will generally be a computing device, configured to implement specific steps upon receipt of data from one or more of the linked sensors. In the context of FIG. 2, upon receiving data from a sensor indicating a potential attack, control 14 will activate one or more thermal deactivation units (i.e., burn boxes). Where multiple sensors and multiple burn boxes are present, control 14 is generally configured to activate the mitigation elements best positioned to mitigate the detected threat.

In certain embodiments, the control element can be eliminated or greatly simplified. In such an embodiment, the sensor elements can be logically coupled to a burn box, such that the burn box is activated when a sensor indicates a specifically identified threat agent is present, or when the sensor detects a potential threat agent. FIG. 2 has been shown indicating a biological sensor element is required (noting that thermal deactivation is particularly well suited for deactivating biological threats); however, it should be understood that burn boxes could be used as a mitigation element in building protection systems that include no biological sensors (i.e., systems that include chemical sensors, but not biological sensors).

The term burn box refers to a device in which air is exposed to sufficiently high temperatures to thermally deactivate biological and/or chemical contaminants and/or threat agents. Burn boxes are conventionally employed in manufacturing environments, such as semiconductor manufacturing, to remove hazardous components from facility air introduced in the manufacturing process. Applicants believe that they are the first to employ a burn box or thermal deactivation unit as a low regret mitigation element in a building protection system. A thermal deactivation unit (or burn box) includes a combustion zone and an fuel injection element (such as an array of nozzles) where the fuel is supplied to the combustion zone, and air to be decontaminated is introduced into a high temperature environment established in the chamber to destroy chemical and biological contaminants in the air. In at least some embodiments, exhaust from the chamber is directed through a filter or wet scrubber. The use of wet scrubbers has the advantage of both cleaning and cooling the decontaminated air. In at least one exemplary building protection system encompassed by the concepts disclosed herein, exhaust from the burn box/thermal deactivation unit is exhausted outside of the facility, to reduce the chance that any residual contamination can endanger people within the facility. In at least one exemplary building protection system encompassed by the concepts disclosed herein, exhaust from the burn box/thermal deactivation unit is reintroduced into the facility via the facility's HVAC system.

As noted above, thermal deactivation units (or burn boxes) are low regret mitigation components, because their activation does not adversely affect the normal operations of the facility, in the event of a false alarm. Activating a burn box (or a plurality of burn boxes distributed throughout a facility) will consume energy resources, and thus incur some cost, without resulting in a major disruption of the facility.

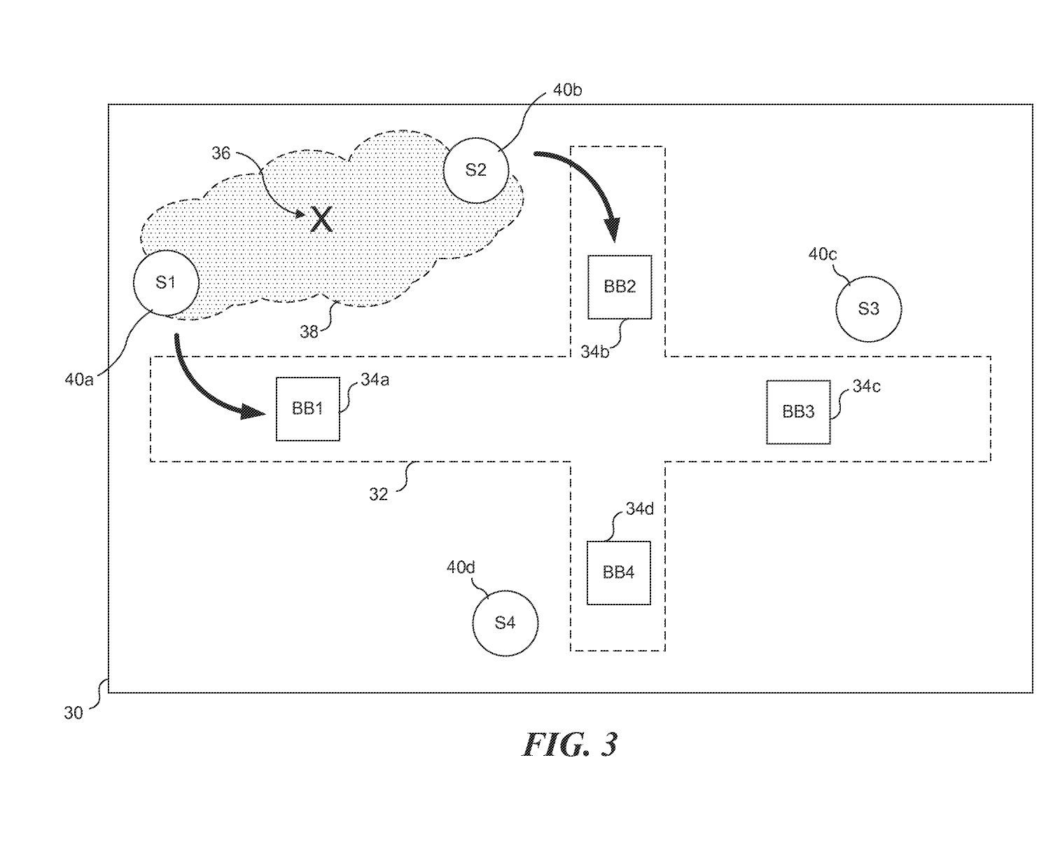

FIG. 3 is a block diagram of an exemplary building protection system including a plurality of sensors and thermal deactivation units distributed throughout the facility to detect and destroy potential biological or chemical threat agents from air inside the facility. A building 30 includes an HVAC system 32, a plurality of burn boxes 34a-34d, and a plurality of sensors 40a-40d. Building 30 as shown includes no interior walls, although it should be recognized that such walls could be used to divide the interior space of building 30 into multiple discrete rooms. Also not shown are data links coupling the sensors to the burn boxes and a control element. Such elements are indicated in FIGS. 1 and 2, and have been omitted from FIG. 3 for simplicity. Finally, it should be recognized that many elements in the HVAC system, such as air inlets, air outlets, air pumps, fans, blowers, filters, and dampers that can be used to change the airflow within the HVAC system have also been omitted to simply the Figure.

As shown in FIG. 3, a chemical or biological threat agent has been released at a location 36 (indicated by the X), and that agent has dispersed throughout an area 38. As the threat agent disperses, it is detected by sensor 40a and sensor 40b. Such sensors can be first tier sensors, which only detect the agents that might be dangerous, without specifically identifying the threat agent, or such sensors can be more sophisticated sensors capable of specifically identifying a threat agent, and conclusively determining that the threat is actual. As soon as sensor 40a detects an actual or potential threat, burn box 34a is activated, and air is drawn into burn box 34a and decontaminated. This will prevent any contaminated air proximate sensor 40a from being dispersed through other parts of the facility via the HVAC system. As soon as sensor 40b detects an actual or potential threat, burn box 34b is activated, and air is drawn into burn box 34b and decontaminated, similarly preventing any contaminated air proximate sensor 40b from being dispersed through other parts of the facility via the HVAC system.

In at least one exemplary embodiment, each sensor is logically coupled to a corresponding burn box, without requiring the sensor to be logically coupled to a central control element. In at least one exemplary embodiment, each sensor is logically coupled to a central controller such as shown in FIGS. 1 and 2, and that controller/control element is logically coupled to the burn boxes. The use of a central control element is beneficial in that such a control element can also be coupled to the building's HVAC system, such that manipulations to the building's HVAC system can be implemented to increase air flow through the HVAC system to bring contaminated air into the burn box proximate a sensor. Such manipulations can include opening and closing dampers in the HVAC system, and using pumps and fans to direct airflow through the HVAC system to bring contaminated air into a burn box.

As shown in FIG. 3, the burn boxes are contained within the HVAC system. It should be recognized that while such positioning is efficient, other burn box dispositions are possible. For example, the burn boxes can be disposed outside of the HVAC system above a ceiling (thus out of sight), and placed in fluid communication with existing HVAC ductwork. It is also possible to place burn boxes inside the building, such that the burn boxes are not even coupled to the HVAC system. For example, a burn box and sensor can be placed in a specific room of a building, such that the sensor triggers burn box activation whenever a threat agent is detected. Such a configuration would require no or minimal modification to a building's HVAC system, while still providing protection and low regret mitigation.

Each burn box can be connected to a central fuel supply, such as natural gas. If the building is not equipped with natural gas, or running additional natural gas supply lines is problematical or expensive, then bottled fuel (such as propane or butane) or a liquid fuel can be stored at each burn box location. Electrically generated high temperature (e.g., by resistance, induction or plasma) could also be used as a heat source, although combustion based technology is readily available as off the shelf units intended for use in manufacturing facilities to treat process gases. Combustion is usually the lowest-cost source of thermal energy.

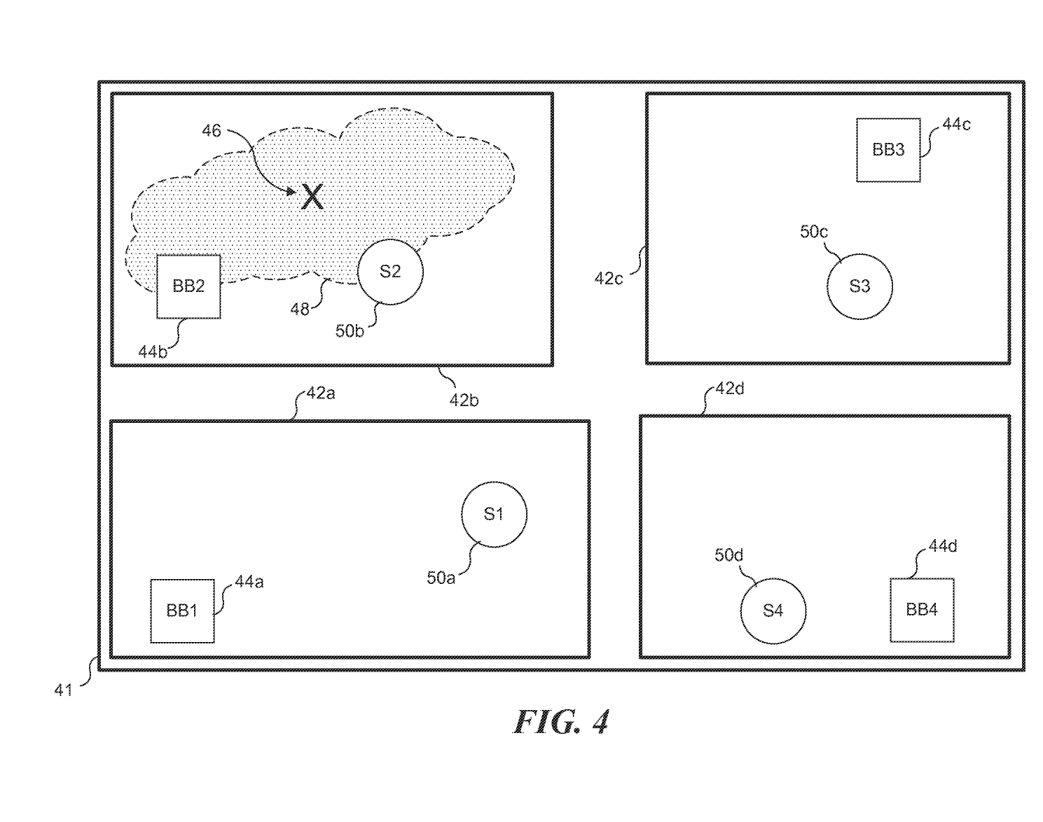

FIG. 4 is a block diagram of an exemplary building protection system including a plurality of sensors and thermal deactivation units distributed throughout different rooms in the facility, to detect and destroy potential biological or chemical threat agents from air inside those specific rooms. A building 41 includes a plurality of protected rooms 42a-42d, a plurality of burn boxes 44a-44d, and a plurality of sensors 50a-50d. Building 41 as shown includes no HVAC system, although such a system maybe present, and if present may be manipulated to reduce the likelihood of threat agents released in one room from being dispersed throughout the facility via the HVAC system. Also not shown are data links coupling the sensors to the burn boxes or a control element. Such elements are indicated in FIGS. 1 and 2, and have been omitted from FIG. 4 for simplicity.

As shown in FIG. 4, a chemical or biological threat agent has been released at a location 46 (indicated by the X), and that agent has dispersed throughout an area 48 in room 42b. As the threat agent disperses, it is detected by sensor 50b. Again, the sensors can be first tier sensors (chemical or biological, or both), which can only determine that a potentially dangerous chemical or biological component is present (with the possibility that the detected agent could be innocuous), without specifically identifying the threat agent, or such sensors can be more sophisticated sensors capable of specifically identifying a threat agent, and conclusively determining that the threat is actual. As soon as sensor 50b detects an actual or potential threat, burn box 44b is activated, and air is drawn into burn box 44b and decontaminated. This will prevent any contaminated air in room 42b from being an ongoing threat to present or future occupants, as well as reducing the likelihood that the threat will be dispersed over time through other parts of the facility via an HVAC system that exchanges air from one room to another. In such an embodiment, the burn box can be equipped with its own air moving elements (fans or pumps) to quickly draw ambient air into the burn box to mitigate the threat.

In at least one exemplary embodiment, each sensor is logically coupled to a corresponding burn box, without requiring the sensor to be logically coupled to a central control element. In at least one exemplary embodiment, each sensor is logically coupled to a central control element such as shown in FIGS. 1 and 2, and that control element is logically coupled to the burn boxes and to the building's HVAC system, such that manipulations to the building's HVAC system can be implemented to prevent air from a contaminated room from being dispersed throughout the building via the HVAC system by closing dampers that allow air from room 42b to enter the HVAC system. Such manipulations to the HVAC system can also include using pumps and fans to change the airflow through the HVAC system to prevent contaminated air from room 42b from dispersing into other parts of the building.

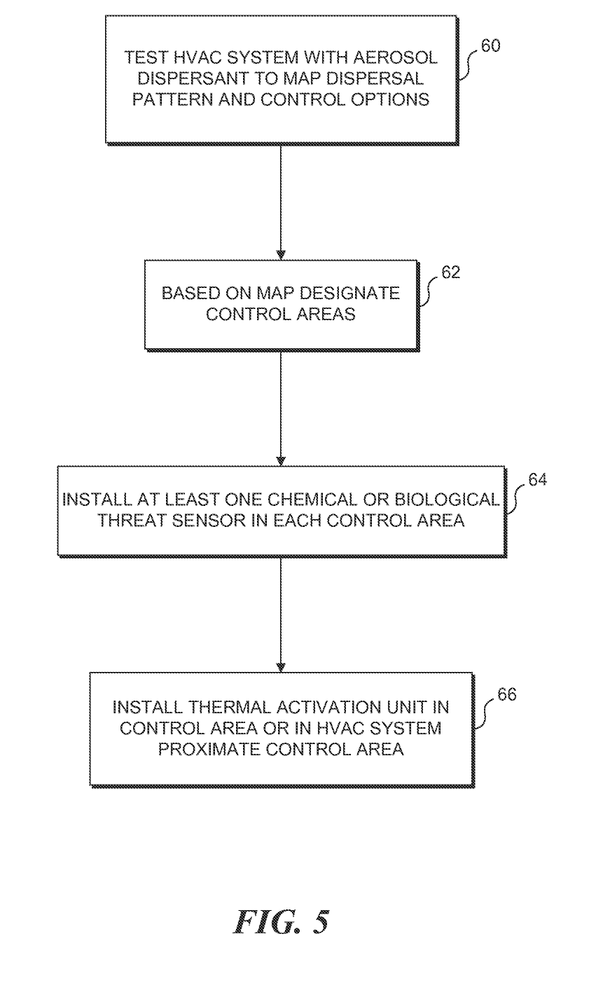

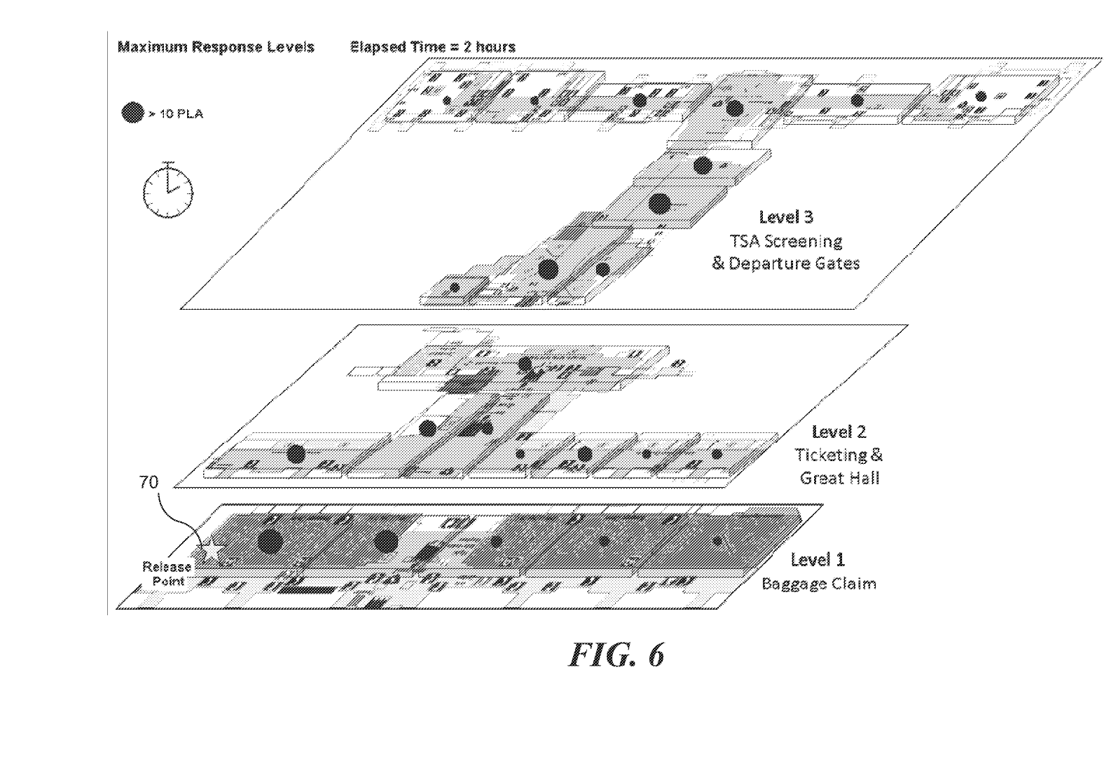

FIG. 5 is a flow chart of an exemplary method to modify an existing facility with an HVAC system to achieve a building protection system including a plurality of sensors and thermal deactivation units distributed throughout the facility, to detect and destroy potential biological or chemical threat agents from air inside the facility. In a block 60, an aerosol dispersant that can readily be tracked and detected is released in the building, and its dispersal throughout the building with the HVAC system operated normally is tracked. FIG. 6 schematically illustrates such a test showing how an aerosol released at a point 70 dispersed throughout an entire multilevel airport in approximately two hours. In addition to performing such a test with the HVAC system operating normally, the test can also be performed while manipulating HVAC elements to reduce the spread of the agent. Components in the HVAC system that can be manipulated include dampers that can be opened and closed to change the airflow through the HVAC system, as well as air pumps and fans used to move air through the HVAC system. These tests will enable a facility airflow map to be generated.

In a block 62, a plurality of control areas in the facility are defined. The control areas are based on the airflow map, and how the HVAC system can be manipulated to prevent airflow from one control area to another. For each defined control area, there exists at least one HVAC component (i.e., a pump, a fan, a blower, or a damper) that can be manipulated to change the airflow in or out of the control area. In a block 64, at least one chemical sensor or biological sensor is installed in each control area. As discussed above, such sensors can be first tier sensors (which can detect potential threats, and which may mistakenly classify an innocuous agent as a threat) or more sophisticated sensors that can positively identify specific threat agents. If desired a radiological sensor can be used as a trigger for the low regret thermal deactivation mitigation element, however, thermal deactivation is generally better suited for destroying chemical and biological threats. Where the burn box is equipped with a wet scrubber or fine particle dry filter, such a filter/scrubber could remove discrete radioactive particles, which would prevent the spread of the radioactive material. The thermal treatment would not reduce the amount of radioactivity present, it would be the filter/scrubber portion of the burn box that captured the radioactivity and prevents its spread.

In a block 66 a thermal deactivation unit (i.e., a burn box) is positioned in fluid communication with the HVAC system (as shown in FIG. 3) or in the control area itself (as shown in FIG. 4). The sensor is either logically coupled directly to its corresponding burn box, or to a central control that is logically coupled to each burn box. In at least one embodiment, there are more sensors deployed than burn boxes. This can be advantageous when a control area is so large that a plurality of sensors are required for adequate coverage, or because both biological and chemical sensors are to be used. Further, depending on the design of the HVAC system, a single burn box might be able to be positioned to treat air collected from more than one control area (i.e., by positioning the burn box at a junction in the HVAC system where air from both control areas is passed onto a different part of the facility).

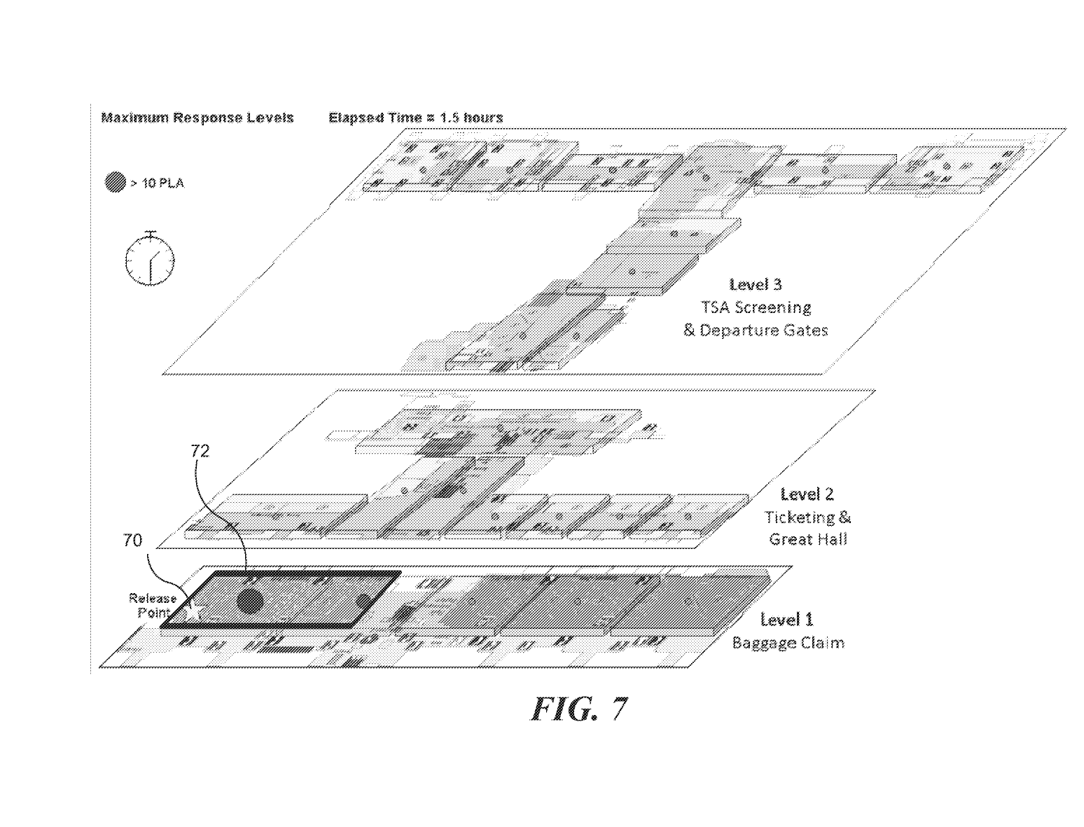

FIG. 7 schematically illustrates how the building protection systems disclosed herein can successfully reduce dispersion of airborne threat agents to only a small portion of the airport shown in FIG. 6. As shown in FIG. 7, the threat agent released at point 70 was contained within a control area 72, and the aerosolized agent was prevented from being spread to other areas. Several different techniques can be used to prevent the spread of the threat agent.

In one exemplary embodiment, the HVAC system was manipulated to prevent air from control area 72 from being dispersed through the facility by the HVAC system. In this embodiment, the HVAC system in control area 72 was switched from normal mode, whereby a large fraction of the air is filtered and then re-circulated, into a 100% exhaust mode. The full exhaust mode slightly lowers the pressure in the control area, causing air from neighboring control areas to flow into control area 72, helping to contain and flush out the contaminated air. In an actual real world test, this reduced the spread of an aerosolized test agent by 90-95%.

In another exemplary embodiment, the HVAC system will be manipulated to direct air from control area 72 into the HVAC system to a burn box, generally as indicated in FIG. 3. In still another exemplary embodiment, the HVAC system will be manipulated to prevent air from control area 72 from being introduced into the HVAC system, and one or more burn boxes in the control area are activated, generally as indicated in FIG. 4. In still another exemplary embodiment, the HVAC continues to operate in normal mode, and one or more burn boxes in the control area are activated, generally as indicated in FIG. 4.

It should be noted that when installing a building protection system as disclosed herein, the existing HVAC system of the building can be modified (by the addition of dampers, air inlets, air outlets, and air moving equipment) at specific locations to enable greater control over the airflow in the building, to enable additional control areas to be defined. The air flow map discussed above will enable the artisan to identify locations where such modifications can be implemented.

The concepts discussed above can be combined in many ways to provide facility protection systems that offer effective, affordable, discrete, and expandable approaches to CBR threat management. The following briefly discusses one such facility protection system with capabilities for detection, protection, and mitigation of CBR threats.

Such an exemplary system offers a comprehensive, layered surveillance system against CBR threats by monitoring the air for chemical and biological threats and screening physical choke points (such as entrances, ticketing counters or security check points) for radiological threats. The system is designed to closely monitor environments for threats in a manner that minimizes operational/lifecycle costs and false alarms through layering of technologies.

The exemplary system is able to: 1) reduce the spread of contamination within the facility; 2) reduce the total number of exposed persons and the doses of the threat agent received; and 3) in a timely manner, collect a sample and deliver it to a local response laboratory for assessment. The system is capable of achieving these objectives without negatively impacting operations, except in the case of an actual WMD event, where such an impact is unavoidable. The system is optimized for each building/facility by defining sensor locations and mitigation element locations by using aerosol tracer testing to map airflows and simulate a chemical and biological threat release. First tier chemical, biological and radiological sensors are installed at defined control areas (chemical and biological) and choke points (radiological). The sensors are logically coupled to a command and control center (i.e., a computer control). Second tier sensors (capable of specifically identifying specific threat agents) are provided to the facility, and personnel are trained in their use, such that when a first tier sensor detects a potential threat, personnel are dispatched to that area to acquire a sample for second tier analysis (so the potential threat can be confirmed as a false alarm or an actual threat). Mitigation elements will include manipulations of existing HVAC control elements, possible modification of the HVAC system to include additional control elements allowing greater control over airflow in specific control areas, and/or the incorporation of thermal deactivation units in control areas themselves, or in fluid communication with the HVAC system.

Commissioning the building protection system will be based on tracer testing, followed by “go-live” exercises that test and validate the effectiveness of the hardware, software, procedures, and training, including a period of provisional operation to assess the system reliability, availability, and maintainability, and the effectiveness of training.

Referring once again to FIG. 6, the Figure represents actual tracer aerosol concentration measurements in particle per liter (PPL) of air resulting from a release in the baggage claim area of the airport where a pilot threat protection system was installed. The results show that for a three-gram release of tracer particles in the baggage claim area, tracer particles were transported throughout the entire facility by the ventilation system and movement of people. Even if no mitigation measures were available, such as adaptive control of the ventilation system, the detection system alone provides a significant benefit to the homeland security mission. First, the possibility that a bio-aerosol event has occurred will be known to security in near real-time, and samples can be collected and analyzed by Tier 2 sensors to definitely identify the threat. Today, Tier 2 testing usually takes approximately one hour, perhaps less in the future. Assuming the event is real, and presumptive identification is positive, the facility can be closed. Although this is highly disruptive to operations, the quality of information available is such that this decision would normally be warranted. If the event indeed involves a real biological agent, a significant number of human exposures will be avoided by taking the precautionary measure of closing the facility.

If active control of the ventilation system is incorporated into the building protection system (as discussed above), significant levels of protection and contamination avoidance are possible. FIG. 7 shows actual tracer test results from a six-gram release of tracer particles in the sample baggage claim location, but in this case, normal airflow in the ventilation system was modified when the sensors in the affected zone were triggered. The mitigation action taken in this case was that the ventilation system in the release area was switched from normal mode into a 100% exhaust mode. Activation of burn box units in fluid communication with a release area will similarly provide a low regret mitigation response. As discussed herein, such burn boxes can be integrated into the ventilation system (as shown in FIG. 3), can be in fluid communication with the ventilation system, or can simply be placed in fluid communication with selected portions of the building (as shown in FIG. 4).

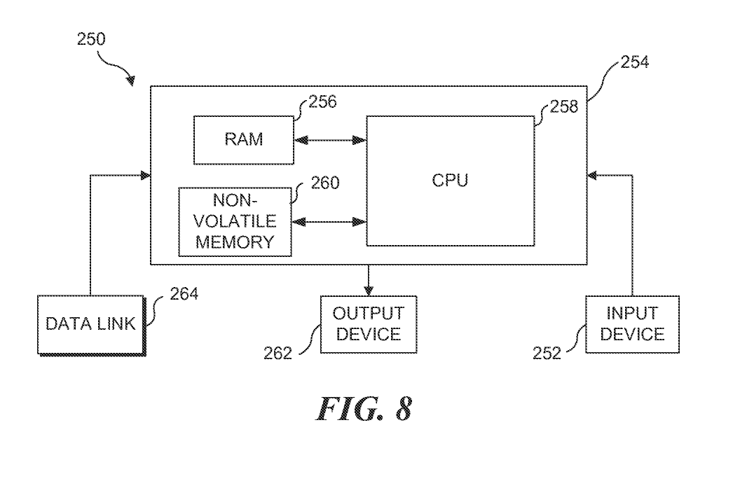

FIG. 8 schematically illustrates an exemplary computing system 250 suitable for use in implementing the control element of FIGS. 1 and 2 (i.e., for receiving sensor data from chemical, biological or radiological sensors, and activating mitigation elements such as air handling components and/or burn boxes). Exemplary computing system 250 includes a processing unit 254 that is functionally coupled to an input device 252 and to an output device 262, e.g., a display (which can be used to output a result to a user, although such a result can also be stored). Processing unit 254 comprises, for example, a central processing unit (CPU) 258 that executes machine instructions for carrying out threat alert notifications and mitigation responses. The machine instructions implement functions generally consistent with those described above. CPUs suitable for this purpose are available, for example, from Intel Corporation, AMD Corporation, Motorola Corporation, and other sources, as will be well known to those of ordinary skill in this art.

Also included in processing unit 254 are a random access memory (RAM) 256 and non-volatile memory 260, which can include read only memory (ROM) and may include some form of memory storage, such as a hard drive, optical disk (and drive), etc. These memory devices are bi-directionally coupled to CPU 258. Such storage devices are well known in the art. Machine instructions and data are temporarily loaded into RAM 256 from non-volatile memory 260. Also stored in the non-volatile memory are operating system software and ancillary software. While not separately shown, it will be understood that a generally conventional power supply will be included to provide electrical power at voltage and current levels appropriate to energize computing system 250.

Input device 252 can be any device or mechanism that facilitates user input into the operating environment, including, but not limited to, one or more of a mouse or other pointing device, a keyboard, a microphone, a modem, or other input device. In general, the input device will be used to initially configure computing system 250, to achieve the desired processing. Configuration of computing system 250 to achieve the desired processing includes the steps of loading appropriate processing software into non-volatile memory 260, and launching the processing application (e.g., loading the processing software into RAM 256 for execution by the CPU) so that the processing application is ready for use. Output device 262 generally includes any device that produces output information, but will most typically comprise a monitor or computer display designed for human visual perception of output. Use of a conventional computer keyboard for input device 252 and a computer display for output device 262 should be considered as exemplary, rather than as limiting on the scope of this system. Data link 264 is configured to enable sensor data collected in connection with operation of a building protection system to be input into computing system 250 for analysis to identify an appropriate mitigation response (i.e., which burn boxes or air handling components should be activated). Those of ordinary skill in the art will readily recognize that many types of data links can be implemented, including, but not limited to, universal serial bus (USB) ports, parallel ports, serial ports, inputs configured to couple with portable memory storage devices, FireWire ports, infrared data ports, wireless data communication such as Wi-Fi and Bluetooth™, network connections via Ethernet ports, and other connections that employ the Internet. Note that while computing system 250 will likely be physically present in the building/facility being protected, the sensor data and mitigation element activation commands could be transmitted to and from a remote location (such a configuration involves the risk that communication between the sensors, the mitigation elements, and computing system 250 could be disrupted).

It should be understood that the term “computer” and the term “computing device” are intended to encompass a single computer as well as networked computers, including servers and clients, in private networks or as part of the Internet. While implementation of the method noted above has been discussed in terms of execution of machine instructions by a processor (i.e., the computing device implementing machine instructions to implement the specific functions noted above), the method could also be implemented using a custom circuit (such as an application specific integrated circuit or ASIC).

The remaining discussion identifies specific readily available sensor technology that can be used to implement the concepts disclosed herein.

The ICx (Arlington, Va.) ChemSense 600™ represents an exemplary first tier chemical detector. This unit is based on direct sampling mass spectrometry (MS), and provides extremely sensitive yet very selective chemical analysis, with the ability to monitor and report “positive” hits in near real-time for a broad range of chemical threats, including chemical warfare agents and toxic industrial chemicals (TICs). The ChemSense 600™ provides continuous indoor air monitoring and detection for building and facilities protection. It rapidly detects chemical contaminants in vapor, with response times under one minute. The ChemSense 600™ is an ideal candidate for building protection systems because of its sensitivity and selectivity in determining benign and threat compounds within a facility that contains a broad range of materials in the ambient air. The device also maintains an updateable library of threats, by which a newly identified threat can be automatically loaded onto an entire network of devices in real time.

The ChemSense 600™ utilizes an advanced cylindrical ion trap (CIT) technology that provides the ability to perform multi-dimensional analysis, or MS/MS. This new breakthrough in MS/MS instrumentation is configured for on-demand deployment, rapid detection, and bi-directional network control and reporting.

Of the potential technologies for chemical detection, mass spectrometry and ion mobility spectrometry (IMS) are the most common candidates. However, IMS suffers from several deficiencies. IMS is subject to interference from commonly encountered chemicals, such as perfumes and soaps. IMS can also produce unacceptably high false alarm rates due to the presence of interferents that have the same ion mobility as a target analyte. False alarms require confirmation and can eventually lead to a loss of faith in the technology among operators.

MS is more selective than is IMS, alleviating many of these issues. MS measures a physio-chemical characteristic: the mass-to-charge ratio (m/z) of an ion. The mass of a species is a definitive and measurable quantity, unlike the detection parameters used by inference systems like IMS. Mass spectrometry can also be adapted as new threats are identified, while also meeting the demands posed by diverse laboratory protocols.

Another option for a first tier chemical sensor is the MSA (Cranberry Township, Pa.) SAFESITE Sentry Chemical Agent Detector™. While not as sophisticated as the ChemSense 600™, the SAFESITE Sentry Chemical Agent Detector™ offers a broad range of modular sensors, and is a continuous-use, permanently mounted detection instrument for facility protection against WMDs. This unit provides superior preventative and countermeasure solutions for homeland security and emergency response. The SAFESITE Sentry Chemical Agent Detector™ integrates several proven technologies to detect advanced threats. The system also offers GPS location technology, pumped flow operation, interchangeable smart sensors (for maximum flexibility), and automatic internal system diagnostics. The following table summarizes the SAFESITE Sentry Chemical Agent Detector™ technology for associated threats.

TABLE 1
SAFESITE Sentry Chemical Agent Detector ™ Summary

| Threat | Technology | Benefit |
|---|---|---|
| Chemical warfare | Surface acoustic | Low false positives and false |
| agents | wave (SAW) | alarms, differentiates between |
| | | nerve and blister agents |
| Volatile organic | Photoionization | 10.6 eV lamp provides ppm |
| compounds | (PID) | readings for broadband toxic |
| | | and VOC detection |
| Toxic industrial | Electrochemical | Detects many specific toxic |
| chemicals | | gases, such as chlorine, |
| | | ammonia, hydrogen cyanide, |
| | | and hydrogen chloride |
| Oxygen deficiency | Electrochemical | Oxygen monitoring for |
| or enrichment | | confined spaces |
| Combustible | Catalytic bead | Wide-range detection for |
| | | hydrocarbons |

Still another option for a first tier chemical sensor is the ChemProFX™ continuously-operating detector from Environics (Abingdon, Md.). This technology provides both Chemical Warfare Agent Detection and Toxic Industrial (TIC) detection in the same detector unit. It is based on the tested and proven Open Loop Ion Mobility Spectrometry (IMS) technology. The unit uses an improved Ion Mobility Cell, which provides improved selectivity and sensitivity.

An exemplary Tier 2 chemical sensor is the Griffin 460™ Mobile GC/MS from ICx Technologies (Arlington, Va.), which couples gas chromatography with mass spectrometry (GC/MS), and offers enhanced performance by providing mass analysis on chromatographically separated chemical components. The Griffin 460™ Mobile GC/MS offers both liquid injection capabilities and complete coverage continuous air monitoring. The Griffin 460™ is an ideal candidate for a building protection system because of its sensitivity and selectivity in determining benign and threat compounds within a facility that contains a broad range of materials in the ambient air. The device also maintains an updateable library of threats, by which a newly identified threat can be remotely loaded onto an entire network of devices in real time.

The Griffin 460™ utilizes cylindrical ion trap technology that provides the ability to perform multi-dimensional analysis, or MS/MS. The MS/MS instrumentation is configured for on-demand deployment, rapid detection, and bi-directional network control and reporting. The Griffin 460™ offers advantages over IMS and other detection technologies by identifying chemicals directly through physio-chemical characteristics with lower susceptibility to interferents. This detection method has 10,000 times the informing power used by inference systems like IMS per the National Research Council. A GC/MS can also be adapted as new threats are identified, while also meeting the demands posed by diverse laboratory protocols.

The ICx X-Sorber™ is a portable, handheld sorbent-based air sampling system used for the collection of vapor-phase samples that will be analyzed with the Griffin 460™. Once a first tier sensor detects a threat, a technician is dispatched to the area to collect a sample for immediate analysis by the second tier sensor (i.e., the Griffin 460™). The X-Sorber™ uses two sorbent-filled pre-concentration tubes to collect samples in series or in parallel (in parallel mode, one tube serves as an archive sample). The system has onboard batteries, sample pump, display, keypad, and GPS electronics. Once sampling is complete, the X-Sorber™ is plugged into the universal sampling port on the Griffin 460™ where the sample, as well as information regarding the collection of the sample, is transferred to the Griffin 460™ for analysis.

The Single Particle MALDI-TOF MS discussed above is an exemplary first tier biological sensor. A less sophisticated exemplary first tier biological sensor is the IBAC™ from ICx Technologies (Arlington, Va.), which uses a combination of light scattering and light-induced fluorescence measurements from single particles. This technology is deployed at U.S. government installations and has been integrated into active biological monitoring architectures with more than 1,250,000 hours of operational run time in relevant environments. The IBAC™ is a continuously operating indoor or outdoor monitor that provides early warning of biological aerosol threats. The IBAC™ facilitates the process of identifying bio-terrorism agents to allow timely containment, treatment, and remediation. Monitors are designed to detect concentrated levels of biological aerosols. Possible agents released in a bio-threat attack can include bacterial spores (such as B. anthracis, which causes anthrax), bacteria (such as Y. pestis, which causes plague), viruses (such as smallpox), and toxins (such as ricin).

The IBAC™ addresses the need for biological aerosol threat detection. Rugged design and high sensitivity allow the IBAC™ to be deployed in severe environments such as outdoor areas and in HVAC systems. The IBAC™ is an affordable approach that offers a range of flexibility to protect high-value assets. IBAC™ detectors can operate independently or as part of a network configuration to form the first tier of an air-security system. In addition to providing real-time alerts to biological aerosol threats, the IBAC™ can trigger a secondary aerosol sampler for subsequent analysis and identification.

Another exemplary first tier sensor is the REBS (Rapid, Enumerated Bio-identification System) available from Battelle Memorial Institute (Columbus, Ohio). REBS is based on RAIVIAN optical spectroscopy, and interrogates single particles impacted from the air onto a surface.

Exemplary Tier 2 biological detectors are based on polymerase chain reaction (PCR) analysis or antibody-based assays. One such PCR based unit is the RAZOR™ from Idaho Technology (Salt Lake City, Utah). The RAZOR™ detects and identifies biological agents using fast, ultra-reliable DNA-based results. Created for first-responders and front line military troops, it is easily operated while working in protective equipment under extreme conditions. The battery-powered unit includes Bluetooth capabilities, bar code reader, and a bright, easy to read color screen.

An exemplary Tier 1 radiation detector is the STRIDE™ gamma detector from ICx Technologies (Arlington, Va.). STRIDE™ gamma detectors self-calibrate and stabilize to allow for consistent accurate monitoring and identification even in the event of environmental changes such as large temperature swings. STRIDE™ gamma detectors are available in security stanchions, waterproof canisters, and weatherproof housings for installations at the entrances to secure buildings, in parking lots, at public events, on the fronts of security vehicles, and in many other security monitoring applications. Multiple detection units are easily configured to not only determine the position of radioactive material but to track its movement, if appropriate. STRIDE™ gamma detectors can be deployed in a variety of covert configurations, such as crowd/pedestrian control stanchions commonly found in airports and banks.

The ICx Technologies (Arlington, Va.) identiFINDER™ is an exemplary Tier 2 radiological detector. The identiFINDER™ is a spectrometer, dose rate meter, and nuclide finder for portable radiation detection and identification applications. This technology combines advanced sensors (e.g., sodium iodide, cadmium-zinc-telluride, lanthanum bromide, helium 3, etc.) with sophisticated analytical engines powered by multi-channel analyzers (MCAs) and high-speed digital signal processors. The identiFINDER™ family of handheld, digital gamma (γ) spectrometer and dose rate measurement instruments allows the user to locate a radioactive or nuclear source and, once found, identify the isotope(s) in an easy-to-use, four-key system. The identiFINDER™ combines high sensitivity with a wide dose rate range, performing γ spectrometry and nuclide identification with performance that meets or exceeds ANSI N42.34 for radiation detection.

As used in the claims that follow, the term air handling equipment encompasses equipment used to heat, cool, or provide ventilation in a building. This term encompasses ductwork, fans, air pumps, and dampers that open or close access to such ductwork. Such elements are commonly referred to as HVAC systems. However, the term HVAC system is not accurate with respect to buildings that include ventilation systems, but not heating elements (as may be appropriate in warmer climates), and buildings that include that include ventilation systems, but not cooling elements (as may be appropriate in colder climates).

As used in the claims that follow, the term minimize should be understood to refer to a substantial reduction. As noted above, empirical testing has indicated changing air handling equipment operating parameters can reduce aerosol dispersion by 90-95%. While the operating parameters of air handling equipment in different buildings are unique, the term minimize should be understood to be a substantial (i.e., greater than about 50%) reduction.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

What is claimed is:

1. A building protection system for a building, comprising:
(a) a sensor capable of detecting an airborne threat agent in a predefined portion of the building; and
(b) a thermal deactivation unit coupled in fluid communication with the predefined portion of the building, the thermal deactivation unit deactivating the airborne threat agent using high temperature in response to the sensor detecting the airborne threat agent.

2. The building protection system of claim 1, wherein the thermal deactivation unit is coupled in fluid communication with an air handling system in the building, such that air treated with the thermal deactivation unit is exhausted out of the building by the air handling system.

3. The building protection system of claim 1, wherein the thermal deactivation unit includes a wet scrubber that cools the treated air to ambient temperature and removes residual particles from the thermal deactivation unit.

4. The building protection system of claim 1, wherein the thermal deactivation unit is disposed in the predefined portion of the building.

5. The building protection system of claim 1, wherein the thermal deactivation unit includes air moving equipment to introduce ambient air in the predefined portion of the building into the thermal deactivation unit, the air moving equipment being separate and distinct from the building's heating, ventilation, and air conditioning system.

6. The building protection system of claim 1, wherein the thermal deactivation unit is disposed in a different portion of the building, and air from the predefined portion of the building in which the airborne threat agent is detected is conveyed to the thermal deactivation unit by air handling equipment in the building.

7. The building protection system of claim 1, wherein the thermal deactivation unit is coupled in fluid communication with air handling equipment in the building.

8. The building protection system of claim 1, further comprising a controller logically coupled to the sensor and the thermal deactivation unit, the controller being configured to activate the thermal deactivation unit in response to receiving a detection signal from the sensor.

9. The building protection system of claim 8, wherein the controller actuates at least one element in an air handling system in the building in response to receiving a detection signal from the sensor, thereby changing airflow in the air handling system.

10. The building protection system of claim 8, wherein in response to receiving a detection signal from the sensor, the controller manipulates an air handling system in the building to implement a full exhaust mode in the predefined portion of the building where the airborne threat agent is detected, so that all exhaust air from the predefined portion of the building where the airborne threat agent is detected is treated by the thermal deactivation unit before being exhausted into an ambient environment.

11. The building protection system of claim 8, wherein the thermal deactivation unit is disposed in the predefined portion of the building, and the controller is further configured to implement the function of manipulating air handling equipment in the building to prevent air in the predefined portion of the building in which the airborne threat agent is detected from being conveyed to other portions of the building via the air handling equipment, in response to the sensor detecting the airborne threat agent.

12. The building protection system of claim 8, wherein the thermal deactivation unit is disposed in a different portion of the building and in fluid communication with air handling equipment in the building, and the controller is further configured to implement the function of manipulating the air handling equipment to direct air in the predefined portion of the building in which the airborne threat agent is detected to the thermal deactivation unit via the air handling equipment, in response to the sensor detecting the airborne threat agent.

13. The building protection system of claim 12, wherein the controller is further configured to implement the function of manipulating the air handling equipment to prevent air from the predefined portion of the building in which the airborne threat agent is detected from being conveyed to a location other than the thermal deactivation unit via the air handling equipment, in response to the sensor detecting the airborne threat agent.

14. The building protection system of claim 1, wherein the sensor is a single particle matrix-assisted laser desorption/ionization time-of-flight mass spectrometer.

15. A building protection system as in claim 1, wherein the building comprises a plurality of predefined control areas, the control areas being defined based on movement of air between different control areas using the building's heating, ventilation, and air conditioning (HVAC) system, comprising:
(a) at least one sensor capable of detecting an airborne threat agent in each predefined control area in the building;
(b) at least one thermal deactivation unit coupled in fluid communication with each predefined control area in the building; and
(c) a controller logically coupled to each sensor and each thermal deactivation unit, the controller being configured to implement the function of activating each thermal deactivation unit in fluid communication with the predefined control area in which the airborne threat agent is detected.

16. The building protection system of claim 15, wherein the thermal deactivation unit is disposed in each predefined control area, and the controller is further configured to implement the function of manipulating air handling equipment in the building to prevent air in the specific predefined control area in which the airborne threat agent is detected from being conveyed to other portions of the building via the air handling equipment, in response to the sensor in that predefined control area detecting the airborne threat agent.

17. The building protection system of claim 15, wherein:
(a) each thermal deactivation unit is spaced apart from its corresponding predefined control area;
(b) each thermal deactivation unit is in fluid communication with air handling equipment in the building; and
(c) the controller is further configured to implement the function of manipulating the air handling equipment to direct air in the predefined control area of the building in which the airborne threat agent is detected to the corresponding thermal deactivation unit via the air handling equipment, in response to the sensor in the predefined control area detecting the airborne threat agent.

18. A method for protecting a building from a chemical or biological threat, the method comprising the steps of:
(a) providing an apparatus as in claim 1;
(b) using the sensor to detect the airborne threat agent; and
(c) in response to the sensor's detection of the airborne threat agent, activating the thermal deactivation unit to destroy the airborne threat agent.

19. The method of claim 18, further comprising the step of using air handling equipment to prevent air proximate the sensor from dispersing into other areas of the building.

20. The method of claim 18, wherein the thermal deactivation unit is spaced apart from the sensor, and further comprising the step of using air handling equipment to convey air proximate the sensor to the thermal deactivation unit.

21. A method as in claim 18, the method comprising the steps of:
(a) providing an apparatus as in claim 1;
(b) using the sensor to detect the airborne threat agent; and
(c) in response to the sensor's detection of the airborne threat agent, implementing the following functions:
(i) activating an air handling system in the building to remove the airborne threat from the building; and
(ii) using the thermal deactivation unit to treat air from the building before it is exhausted into an ambient environment.

22. A method as in claim 18, the method comprising the steps of:
(a) releasing an aerosolized test agent in the building to map airflow within the building, during both normal operation of air handling equipment in the building and while manipulating the air handling equipment to minimize dispersion of the test agent;
(b) using the airflow map to define a plurality of control areas in the building, manipulation of the air handling equipment enabling dispersion of airborne agents from each control area to other control areas to be substantially reduced;
(c) providing an apparatus as in claim 15;
(d) automatically activating each thermal deactivation unit when the airborne threat agent is detected in the control area with which the thermal deactivation unit is in fluid communication.

23. The method of claim 22, further comprising the step of automatically manipulating the air handling equipment to minimize dispersion of the detected airborne threat agent to other control areas.

24. A building protection system for a building, comprising:
(a) an airborne biological threat agent sensor, selected from the group consisting of:
(i) a single particle matrix-assisted laser desorption/ionization time-of-flight mass spectrometer sensor capable of detecting an airborne threat agent in a predefined portion of the building, and positively identifying the threat agent;
(ii) a single particle RAMAN optical sensor; and
(iii) a single-particle combined light scattering and laser-induced fluorescence sensor; and
(b) a low regret mitigation component coupled in fluid communication with the predefined portion of the building, the low regret mitigation component responding to the sensor detecting the airborne threat agent by implementing at least one of the following functions:
(i) deactivating the airborne threat agent using high temperature; and
(ii) manipulating the building's heating, ventilation and air conditioning system to prevent air from the predefined portion of the building from dispersing to other portions of the building.
